(19) United States
(12) Patent Application Publication
(10) Pub. No.: US 2010/0306820 A1
(43) Pub. Date: Dec. 2, 2010

(54) CONTROL OF MESSAGE TO BE TRANSMITTED FROM AN EMITTER DOMAIN TO A RECIPIENT DOMAIN

(75) Inventors: Patrick Battistello, Perros-Guirec (FR); Quentin Loudier, Pleumeur Bodou (FR); Yvon Gourhant, Lannion (FR)

Correspondence Address: LOWE HAUPTMAN HAM & BERNER, LLP, 1700 DIAGONAL ROAD, SUITE 300, ALEXANDRIA, VA, 22314, US

(73) Assignee: FRANCE TELECOM

(21) Appl. No.: 12/445,584

(22) PCT Filed: Oct. 2, 2007
(86) PCT No.: PCT/FR07/52057

§ 371 Date: Aug. 16, 2010

(30) Foreign Application Priority Data
Oct. 16, 2006 (FR) 0654294

(51) Int. Cl. G06F 21/00

(52) U.S. Cl. 726/3

(57) ABSTRACT

For controlling a message to be transmitted by a sender linked to a sender domain, from a terminal connected to an emitter domain to at least one recipient linked to a recipient domain, the emitter domain requests an authentication of the sender of the message by the sender domain. In response to a first request transmitted from the emitter domain, the recipient domain transmits a second request to the sender domain that transmits it to the emitter domain if data previously transmitted from the sender domain to the emitter domain are identical to data contained in the second request. The emitter domain transmits a response to the recipient domain so that the recipient domain receives the message from the emitter domain and transmits it to a recipient having accepted the message.

The present invention relates to a message control to be transmitted from an emitter domain to a recipient domain via a telecommunications network.

The telecommunications networks, such as the internet, transmit data via a common infrastructure between different service entities, such as a web server, or an electronic mail server. Such networks are subjected to attacks directed to professional, administrative or individual targets. For example, an attack consists in sending to the largest number of recipients possible unwanted messages that they have not asked for, such as “Spam” for electronic mails or “Spit” for telephone calls on internet. The term “unwanted” is taken in the largest sense and applies both to the identity of the message sender, that can be genuine or fake, and to the message content.

For example, developing the Spam lies on the following factors:
the weakness of the protocols as used on internet, such as the SMTP protocol (“Simple Mail Transfer Protocol”) as most commonly used for transferring electronic mail and that does not incorporate any functions for authenticating the emitter of a mail for example;
the increase of the power of computers able to send automated mass unwanted messages on a very short period;
the increase of the number of networks on internet and the connectivity between the networks, which presents a very large number of targets to hackers likely to shelter behind relatively permissive networks or out of legal or administrative reach of the target networks.

Furthermore, an emitter domain can relay a message as emitted by a sender being connected to the emitter domain and not linked administratively or through a contract to the emitter domain, to a recipient domain. For example, a roaming sender connected to an emitter domain “emitter.fr” sends an electronic mail with the source address “user@sender.fr” and the destination address “user2@recipient.fr”. Currently, the emitter domain is not able to determine whether the sender address is valid, that is whether the sender address is effectively attributed in the sender domain “sender.fr” and whether the sender has the rights for sending a message from that address, as the emitter domain does not manage identities, i.e. the logic addresses “sender.fr”. Such controlling absence is often used by hackers for sending messages with a fake identity from a domain to which hackers have access or even, via a corrupted machine in a legitimate domain.

A solution to this controlling absence consists in blocking in the emitter domain sending any message whose source address is not linked to the emitter domain, but this solution is too limitative, including for the mobility of “voice over IP” VoIP services (“Voice over Internet Protocol”) with which a roaming terminal can use a third party relay such as an emitter domain for establishing a telephone call.

Different methods have been developed for fighting sending unwanted messages.

Some methods provide analyzing the content of messages as a function of some criteria, such as key words, or message signatures, and inferring from them potentially unwanted messages.

Other methods comprise detecting the source from which unwanted messages originate as a function of traffic behaviours and optionally, signature analyses, so as to block the traffic of unwanted messages as closely as possible to the detected source.

According to third methods, the traffic sources are classified into different categories as a function of the confidence reputation they present, for example, by means of black or white lists of addresses reputed to be dangerous or not.

According to fourth methods, the authenticity of a user of a service on internet is checked so as to make responsible the internet providers or the emitter domains from which messages are sent, for example, certifying the identity provided by the user or requiring the user to pass a test before sending a message.

Fifth methods rely on the previous sending of a notification by the sender of a message to a recipient, the latter having to accept the notification so as to receive the message.

All those methods have the drawback that a message is checked in the recipient domain last receiving messages without the latter interacting with the emitter domain of the message, the recipient domain being then unable to trust the upstream performed controls. Furthermore, some methods have this drawback that it is needed to implement a public key infrastructure PKI.

In order to overcome the above-described drawbacks, a method according to the invention for controlling a message to be transmitted by a sender terminal connected to an emitter domain, to a recipient domain, the sender being linked to a sender domain, is characterized in that it comprises the following steps, as a result of an authentication of the sender of the message by the sender domain:

transmitting sender domain data from the sender domain to the emitter domain and a notification request containing said data from the emitter domain to the recipient domain,

in response to the reception of the notification request, transmitting a notification confirmation request containing said data from the recipient domain to the sender domain,

if the data contained in the notification confirmation request are identical to the data transmitted from the sender domain as a result of the authentication of the sender, transmitting back said request from the sender domain to the emitter domain, and

in response to receiving the notification confirmation request, transmitting a notification confirmation response from the emitter domain to the recipient domain.

The message can then be transmitted from the emitter domain to at least one recipient terminal that has supplied a definitive agreement for receiving the message to the recipient domain.

The invention advantageously controls any message transmitted by a sender from an emitter domain to a recipient domain, the sender domain to which the sender is linked interacting with the emitter domain and the recipient domain. The invention thus generates some responsibility of the emitter domain interfering in the controlling of a message emitted from the latter and some responsibility of the sender domain that has to authenticate the sender of the message. The emitter and sender domains then commit themselves so that the message would not be unwanted.

Furthermore, the method of the invention is independent from the architecture of the network in which it is implemented. In particular, the method of the invention provides for an implementation consistent with the existing message sending protocols, such as the SMTP protocol for electronic mail applications. On the other hand, checking the origin of the message can be carried out by the recipient domain, whatever the number of relay servers having transmitted back the message to the recipient domain.

According to a feature of the invention, authenticating the sender of the message further comprises authenticating the identity of the sender and validating rights needed for claiming the identity by the sender domain, as a result of an exchange of data between the sender domain and the sender terminal.

Advantageously, the invention prioritizes a control on the origin of the message rather than the content of the message, calling in particular for the sender domain that authenticates the identity of the sender and the rights needed for claiming the identity. Indeed, the controls relying on filtering algorithms filtering the content of the message can be overcome by a hacker if he knows the filtering algorithms. Moreover, most messages having their origin faked are generally unwanted, whereas, conversely, most messages having their origin genuine are not unwanted.

According to another feature of the invention, after receiving the notification confirmation response, the recipient domain can generate a refusal list, a definitive agreement list and a provisional agreement list including identifiers of the recipients for which a reception of the message is respectively refused, definitively agreed and provisionally agreed, and transmits a notification response containing the lists to the emitter domain.

According to still another feature of the invention, if the definitive agreement list includes at least a recipient identifier, the notification response contains a definitive key, and after receiving the notification response, the emitter domain transmits an authenticated message containing the message and the definitive key to the recipient domain so that the latter transmits the message to at least one terminal of a recipient, the identifier of which is included into the definitive agreement list, after validating the definitive key contained in the authenticated message.

Message controlling according to the invention implies soonest the recipient of a message in the choice for receiving said message so as to obtain preliminarily to any transmission of message to the recipient domain, the explicit or implicit agreement of the recipient for receiving the message, provided that the identity of the sender of the message has been preliminarily confirmed. The identity of the sender generally corresponds to a logic address having a format typical of the protocol under consideration.

Furthermore, message controlling according to the invention reduces the volume of useless or unwanted messages flowing through the telecommunications network and obstructing message relay servers, as well as the recipients' receiving boxes when messages are electronic mails.

The invention also relates to a system for controlling a message to be transmitted by a sender terminal connected to an emitter domain, to a recipient domain, the sender being linked to a sender domain. The system is characterized in that it comprises:
means in the sender domain for transmitting sender domain data to the emitter domain, as a result of an authentication of the message sender by the sender domain,
means in the emitter domain for transmitting a notification request containing said data to the recipient domain,
means in the recipient domain for transmitting a notification confirmation request containing said data to the sender domain in response to the reception of the notification request,
means in the sender domain for transmitting back the notification confirmation request to the emitter domain, if the data contained in the notification confirmation request are identical to the data transmitted by the sender domain as a result of the authentication of the sender, and
means in the emitter domain for transmitting a notification confirmation response to the recipient domain, in response to receiving the notification confirmation request.

The invention is also related to an entity in an emitter domain for controlling a message to be transmitted by a sender terminal connected to the emitter domain, to a recipient domain, the sender being linked to a sender domain, characterized in that it is adapted for:

transmitting a notification request containing data from the sender domain to the recipient domain, after receiving said data transmitted by the sender domain as a result of an authentication of the sender of the message by the sender domain, so that in response to receiving the notification request, the recipient domain transmits a notification confirmation request containing said data to the sender domain, and

transmitting a notification confirmation response to the recipient domain in response to receiving the notification confirmation request that has been transmitted back from the sender domain to the emitter domain if the data contained in the notification confirmation request are identical to the data transmitted by the sender domain as a result of the authentication of the sender.

This invention is also related to an entity in a sender domain for controlling a message to be transmitted by a sender terminal connected to the emitter domain, to a recipient domain, the sender being linked to the sender domain, characterized in that it is adapted for:

transmitting data from the sender domain to the emitter domain, as a result of an authentication of the sender of the message by the sender domain, and

transmitting back a notification confirmation request containing said data to the emitter domain, if the data contained in the notification confirmation request are identical to the data transmitted by the sender domain as a result of the authentication of the sender, said request having been transmitted back by the recipient domain to the sender domain in response to receiving a notification request containing the data transmitted from the emitter domain to the recipient domain as a result of the authentication of the sender, so that the emitter domain transmits a notification confirmation response to the recipient domain.

Finally, this invention relates to computer programs adapted to be implemented in part in an entity included in an emitter domain and in part in an entity included in a sender domain for controlling a message transmitted by a sender terminal linked to the emitter domain, to a recipient domain, the sender being linked to the sender domain. The programs comprise instructions which, when said programs are executed respectively in said entities, perform the steps according to the method of the invention.

Other features and advantages of the present invention will become more clearly apparent on reading the following description of several embodiments of the invention, given by way of nonlimiting example, with reference to the corresponding appended drawings, in which:

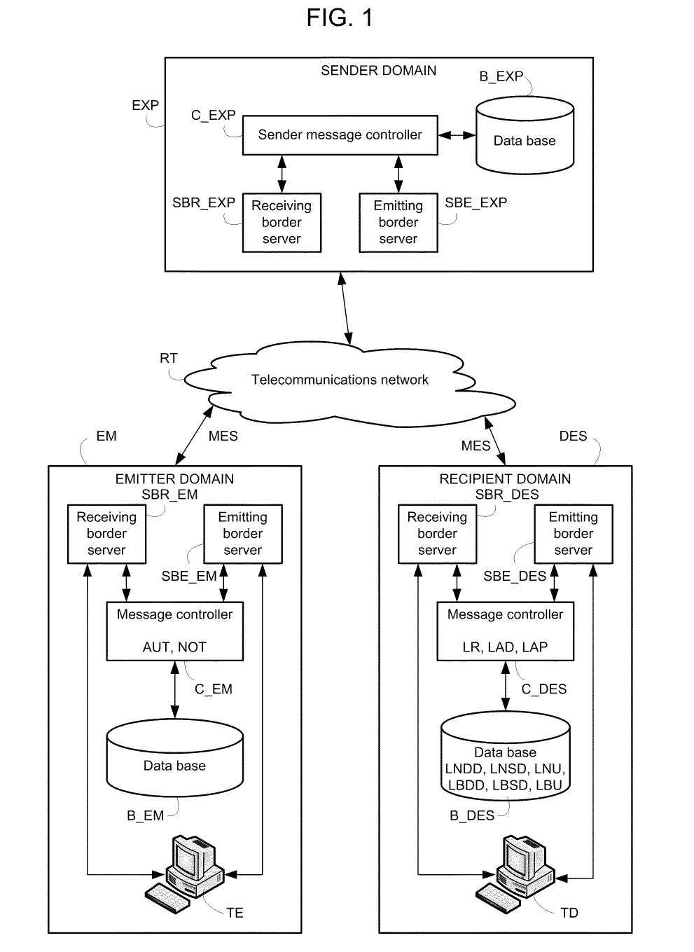

FIG. 1 is a schematic block diagram illustrating a controlling system according to the invention distributed between an emitter domain, a sender domain and a recipient domain linked between them via a telecommunications network; and

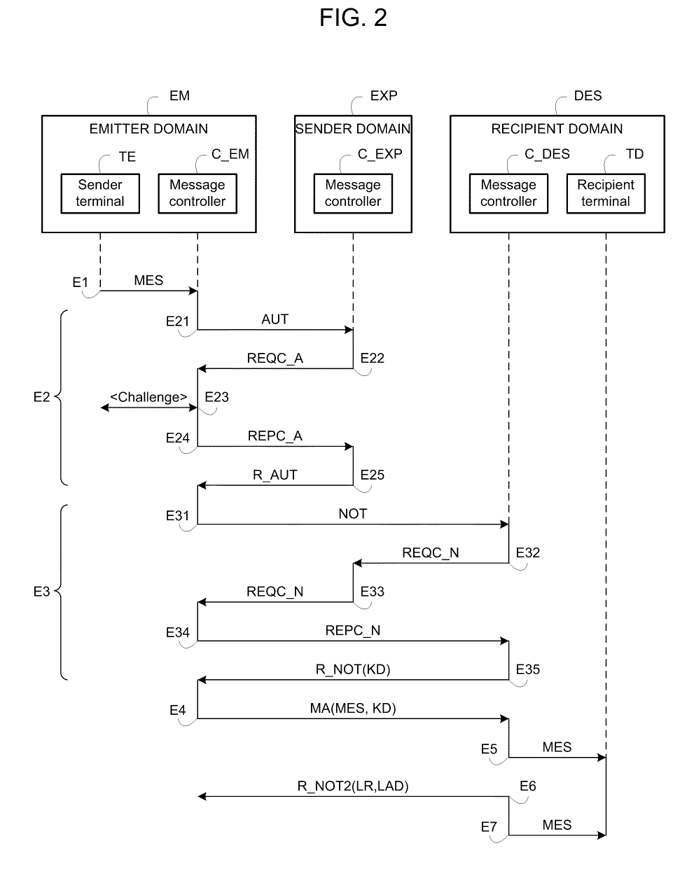

FIG. 2 is a flow chart of a method according to the invention for controlling a message to be transmitted from the emitter domain to the recipient domain.

Referring to FIG. 1, a telecommunications system includes an emitter domain EM, a sender domain EXP and a recipient domain DES communicating between them via a telecommunications network RT.

The emitter EM, sender EXP and recipient DES domains comprise respectively an emitter message controller C_EM, a sender message controller C_EXP and a recipient message controller C_DES forming a controlling system according to the invention.

The emitter domain EM and recipient domain DES respectively comprise one or more sender terminals TE and one or more recipient terminals TD. Each domain EM, EXP, DES comprises a receiving border server SBR_EM, SBR_EXP, SBR_DES and optionally an emitting border server SBE_EM, SBE_EXP, SBE_DES which are positioned at the boundary between the domain and the telecommunications network RT. Alternatively, the emitting and receiving border servers in one domain are merged between them. Moreover, in one domain, the message controller can be partially or completely integrated into one or another of the emitting and receiving border servers linked to the domain.

The controllers C_EM, C_EXP and C_DES are respectively linked to data bases B_EM, B_EXP and B_DES so as to store the information related to the requests and responses exchanged between the controllers.

In each of the emitter domain EM, sender domain EXP and recipient domain DES, the emitting border server SBE_EM, SBE_EXP, SBE_DES and the receiving border server SBR_EM, SBR_EXP, SBR_DES implement message emitting and receiving functions and communicate with the sender and recipient terminals, either directly or via at least one relay server.

A border or relay server is an entity able to receive a message and to send back this message to the terminal of the message recipient or to another entity closer to said terminal. For example, in electronic mail applications relative to the emitter domain EM or to the recipient domain DES, a relay server is typically a “Mail Transfer Agent” MTA in the core of a network linked to the domain, and a border server is typically a “Mail Delivery Agent” MDA peripherally to the network. For example, in “voice over IP” applications, the border and relay servers are “proxy” servers. In all cases, such servers have available static or dynamic routing tables for relaying a message to the desired recipient.

The emitter EM, sender EXP and recipient DES domains can be divided into several sub-domains. In such a case, each sub-domain comprises at least a message controller and a receiving border server, and the message controllers of the sub-domains are cooperatively interconnected, so as to distribute the processing load of the messages.

In an embodiment, the emitter domain EM does not comprise any emitting border server SBE_EM. For example, for some messaging applications, sender terminals TE are linked directly to the telecommunications network RT such as the internet and send electronic mails without relying to an emitting border server SBE acting as a messaging relay under the control of the access provider to the internet. In such a case, the emitter message controller C_EM intercepts the messages generated by the sender terminals and sends itself output messages to the recipient domain.

In another embodiment, the emitter domain EM has a strongly distributed architecture and an emitter message controller C_EM is implemented in each sender terminal.

Further in the description, a sender message MES is a set of data of any nature transmitted between the emitter and the recipient domains. For example, a message contains an electronic mail, or packets of a multimedia dialog, such as dialog initiating packets. The transmission of the message can be of any type, for example relative to a bidirectional dialog or to an unitary message sending, and independent from the features of the transport network being used, the latter being either in a connected mode or in a non-connected mode. A sender message MES is emitted from a sender terminal TE of the emitter domain to one or more recipient terminals TD of the recipient domain. A recipient terminal can be for example a personal computer, a mobile, or a messaging server directly accessible through terminals.

A message emitted from the emitter domain to the recipient domain can cross one or more intermediary domains, as a function of routing policies between the operators relative to the emitter and recipient domains. Each intermediary domain comprises one or more relay servers which route the message towards the recipient domain. In general, for messaging services, the emitting border server in the emitter domain communicates directly with the receiving border server in the recipient domain, without passing through intermediary domains.

Optionally, the data base B_DES linked to the recipient message controller C_DES contains lists of sender addresses, such as a black list LNDD of addresses forbidden within the recipient domain, a black list LNSD of addresses forbidden within a sub-domain of the recipient domain and a black list LNU of addresses forbidden by one user, or at least one of the previous lists. The data base can also contain a white list LBDD of addresses authorized within the recipient domain, a white list LBSD of addresses authorized within a sub-domain of the recipient domain and a white list LBU of addresses authorized by a user, or at least one of the previous lists.

The emitter message controller C_EM and the sender message controller C_EXP communicate between them in particular for offset authenticating the sender of a message.

In an embodiment, the sender is linked in an administrative or contractual mode to the emitter domain EM managing the address of the sender or the sender terminal TE. In such a case, the emitter EM and sender EXP domains are merged between them.

For example, if the emitter domain is “emitter.fr” and the sender is identified under the logic address “user@emitter.fr”, then the offset authentication is not performed as the sender domain coincides with the emitter domain. In contrast, if the sender is identified under the logic address “user@sender.fr”, then the offset authentication is necessary as the emitter domain is not able to authenticate the identity as presented by the sender and to validate the rights necessary for using such an identity.

The emitter message controller C_EM generates authentication requests AUT and notification requests NOT comprising routing information and following information elements pooled into a set of data called notification aggregate and denoted as {Notification}.

<Sender>: such element contains a logic address of the sender according to a format which is typical of the application under consideration. Generally, the logic address comprises an identifier, which designates the user or the used terminal, and a domain name whereto the user is administratively or contractually linked. For example, for an electronic mail application, the format of such an element is an address of the “identifier@sender.fr” type, and for a phone application on the internet, the format of such an element is an address of the “<sip:identifier@domain.fr>” type. Such an address can be part of a set of addresses managed by the emitter domain, or even be linked to the sender domain. The logic address contained in the element <Sender> is different from a transport address making it possible to route packets in the network and being of the “w.x.y.z” type for a network IP. Optionally, a transport address can complete or being substituted for the logic address contained in the element <Sender>.

<Emitter>: such element contains the address of an entity that generates a notification or authentication request if applicable and that will process a response to the notification or authentication request. This address can be the own address of the emitter message controller C_EM, or merely the name of the emitter domain, or even the same address as that contained in the element <Sender> if the sender domain coincides with the emitter domain. Thus, the emitting element contains either an address of the logic type or an address of the transport type

{<Recipient>}: such an element, of the list type, contains the set of the addresses of the recipients to which the message is sent, generally designating the logic addresses of recipients or alternatively the transport addresses of the recipient terminals. The format of each <Recipient> is the same as that of the element <Sender> and the list comprises at least one element. Furthermore, each notification request only contains the elements <Recipient> belonging to the same recipient domain. Consequently, if a sender sends a message to recipients belonging to different domains, the emitter message controller C_EM generates as many notification requests as different recipient domains.

<KI>: such element contains an initial key generated by the emitter message controller C_EM for identifying an authentication request or a notification request. For example, the initial keys generated for each request have the same length.

Optionally, a notification request contains other elements useful for the application under consideration such as, for example, the following information elements.

<Subject>: such an element indicates the object of the message for guiding the message recipient in the case where an explicit agreement is requested from the recipient to accept the message.

<Signature>: such an element contains a signature of the message so as to ensure the integrity of the content of the message or of its origin. The signature can be performed, for example, using a secret or private key generated by the emitter domain. In order to be valid, the signature should relate to part of the message that is unlikely to be modified by intermediary servers.

In abbreviation, the notification aggregate can be written:

{Notification}=<Sender>+<Emitter>+{<Recipient>}+<KI>+(<Subject>)+(<Signature>),

where the operator ‘+’ designates the concatenation of elements and the elements between brackets are optional.

Referring to FIG. 2, the message controlling method according to the invention comprises steps E1 to E7 performed in the telecommunications system.

It is assumed that the emitter EM and sender EXP domains are not merged between them.

In the starting step E1, a sender wishes to send a message MES to one or more recipients via the sender terminal TE. After the message has been validated by the sender, the emitter message controller C_EM intercepts the message to be sent by the sender terminal to the recipients. The message MES is for example an electronic mail or the establishment of a telephone call on the internet.

The message MES is temporarily stored in the emitter message controller C_EM before being optionally transmitted to one or more recipients via the recipient domain.

Before any communication between the emitter domain EM and the recipient domain DES, the emitter message controller C_EM checks whether the sender is legitimate in an authentication phase in steps E21 to E25 making up the step E2. In particular, the controller C_EM checks whether the identity of the sender is defined and attributed in the sender domain and whether the sender possesses the rights necessary for claiming such an identity.

In step E21, the emitter message controller C_EM generates an authentication request AUT to be transmitted to the sender message controller C_EXP.

The emitter message controller C_EM extracts information contained in the message MES received from the sender terminal TE for generating a notification aggregate {Notification} that contains in particular the elements <Sender>, <Emitter>, {<Recipient>} and <KI>, and that is afterwards inserted into an authentication request AUT. For example, the controller C_EM informs the sender that the message MES will be subjected to a remote authentication phase because the emitter and sender domains are different.

Then the emitter message controller C_EM transmits the authentication request AUT to the transport address of a receiving border server SBE_EXP in the sender domain, or to the transport address of the sender message controller C_EXP if the latter is determined. For example, the transport address to which the authentication request is transmitted is determined by looking up preconfigured translation tables or by means of requests for resolution of the domain name DNS (“Domain Name Server”), after extraction of the domain name contained in the element <Sender>.

In parallel to the transmission of the authentication request AUT, the information relative to the authentication, including the notification aggregate {Notification}, is stored in the data base B_EM managed by the emitter message controller C_EM.

In step E22, the sender message controller C_EXP receives the authentication request AUT and extracts therefrom the notification aggregate {Notification}, in particular the elements <Sender>, <Emitter> and the initial key contained in the element <KI>.

Optionally, the sender message controller C_EXP checks whether the transport address source in the authentication request AUT belongs to the addresses attributed to the emitter domain.

The sender message controller C_EXP performs one of the three following authentication policies the choice of which optionally depends on the content of the element <Emitter> or <Sender>.

According to a first authentication policy referred to as “total”, the sender message controller C_EXP generates an authentication confirmation aggregate {Conf_Authentication} containing the notification aggregate {Notification}, an authentication aggregate {Authentication} and, optionally, an element <MAC_AUT>. The aggregate {Notification} can be reduced to the most compact shape possible by only holding, for example, the elements <Emitter>, <Sender> and <KI>. The aggregate {Authentication} contains an aggregate {Challenge} and optionally the elements <Hour>, <KE> and <Origin>.

The element <Hour> is an authentication time marker optionally including a validity limit hour. The element <KE> is a token randomly generated at each authentication for uniquely identifying the authentication confirmation aggregate. The element <Origin> contains the transport address from which the authentication request AUT has been received. The aggregate {Challenge} contains a set of data referred to as “challenge” that the emitter domain is to exchange with the sender terminal in order to authenticate the identity of the sender. For example, the transmitted challenge contains a random element that the sender terminal TE should cipher with a password attributed to the sender and transmit back to the controller C_EXP. The ciphered random element should correspond to a result expected by the controller C_EXP so that the challenge can be acceptable. The element <MAC_AUT> is an authentication code calculated by the controller C_EXP on the concatenation of the aggregates {Notification} and {Authentication} while using for example a secret or a private key being periodically renewed.

In abbreviation, the authentication confirmation aggregate can be written:

{Conf_Authentication}={Notification}+{Authentication}+(<MAC_AUT>), with:

{Authentication}={Challenge}+(<Hour>)+(<KE>)+(<Origin>), and

<MAC_AUT>=MAC ({Notification}+{Authentication}) wherein MAC is a function for calculating an authentication code by using a secret or a private key, the operator ‘+’ designates the concatenation of elements and the elements between brackets are optional.

Then the sender message controller C_EXP generates and transmits an authentication confirmation request REQC_A containing the authentication confirmation aggregate towards the transport address from where the request AUT has been received.

According to a second authentication policy, referred to as “partial”, the sender message controller C_EXP transmits an authentication confirmation request REQC_A identical to that generated according to the “total” authentication policy, with the difference that the request does not contain the aggregate {Challenge}. Advantageously, the “partial” authentication policy makes it possible to check the validity of the transport address, from which the authentication request AUT comes, while consuming less resources in the sender domain than the “total”' authentication policy.

According to a third authentication policy referred to as “direct”, the sender message controller C_EXP does not generate any authentication confirmation request REQC_A and the method pursues directly to step E25 as described hereinafter, for a validation of the sender identity contained in the element <Sender>. According to such a “direct” authentication policy, the consumption of resources in the sender domain is limited as it does not require any storing nor code calculation MAC by the sender message controller C_EXP.

In parallel to the generation of the request REQC_A and as a function of the processing and storing resources, the controller C_EXP has available therein, the latter adopts one of the three following local storage policies.

According to the first storage policy referred to as “minimal”, the controller C_EXP does not store any element of the request REQC_A in the data base B_EXP and calculates the authentication code <MAC_AUT> ensuring the integrity of information elements it relates to and being inserted in the request REQC_A. Such a “minimum” policy does not consume any memory resource, but requires additional processing resources for transmitting the request REQC_A and controlling a response to the request REQC_A.

According to the second storage policy, referred to as “mean”, the controller C_EXP stores minimum information associated to the content of the request REQC_A that serves afterwards as a research key upon receiving a response to the request REQC_A. For example, the research key for the request REQC_A is the element <KE> or the element <KI> in the absence of an element <KE>. The sender message controller C_EXP stores the research key in the data base B_EXP, calculates and inserts the <MAC_AUT> code in the request REQC_A. Such a policy consumes minimum memory resources while reducing the processing resources upon reception of an attack by flooding.

According to the third storage policy referred to as “maximum”, the controller C_EXP stores the aggregate {Conf_Authentication} without calculating nor inserting the authentication code <MAC_AUT> in the request REQC_A. Such a policy requires few processing resources as it does not perform any <MAC_AUT> code calculation; instead, it is a high consumer of memory resources, making it vulnerable to attacks by flooding.

In step E23, the emitter message controller C_EM receives the authentication confirmation request REQC_A and extracts therefrom the authentication confirmation aggregate, in particular the initial key contained in the element <KI>. If such an initial key corresponds to an initial key already stored in the data base B_EM of the controller C_EM, then the processing of the request REQC_A is continued. In the opposite case, the request REQC_A is not processed and the method is ended.

If the authentication confirmation aggregate does not contain any aggregate {Challenge}, in the case of a “partial” authentication policy as adopted in step E22, the emitter message controller C_EM directly performs step E24.

If the authentication confirmation aggregate {Conf_Authentication} contains an aggregate {Challenge} transmitted by the sender domain, the controller C_EM provides the set of data contained in the aggregate {Challenge}, that is the challenge, to the sender terminal TE such as identified by the element <Sender> of the aggregate {Notification} corresponding to the element <KI>. The sender terminal TE should then send back a response to the controller C_EM. If no response to the challenge has been received by the sender terminal in a restricted period of time, then the step E23 is considered as failing and the method is ended; in the opposite case, the step E24 is performed.

In step E24, the controller C_EM generates an authentication confirmation response REPC_A and transmits it to the transport address from which the authentication confirmation request REQC_A has been received or alternatively, to the transport address, the authentication request AUT has been sent to.

The authentication confirmation response REPC_A comprises the authentication confirmation aggregate {Conf_Authentication}, such as extracted from the authentication confirmation request REPC_A, and if applicable, an appropriate element <Response-Challenge> containing the response to the challenge as sent back by the sender terminal, that is, for example, a ciphered data.

In step E25, the sender message controller C_EXP receives the authentication confirmation response REPC_A and extracts therefrom the authentication confirmation aggregate and the element <Response-Challenge> if the latter is present.

Optionally, the controller C_EXP controls the time validity of the response, on the basis of the element <Hour>. The same element <Hour> can be used by the controller C_EXP for finding the secret or private key that it had used if appropriate for calculating the authentication code <MAC_AUT> in the authentication confirmation request REQC_A.

Optionally, the controller C_EXP checks whether the transport address from where the authentication confirmation response REPC_A is identical to that contained in the element <Origin> of the aggregate {Authentication} if such an element is present.

Then the controller C_EXP checks the validity of the response REPC_A according to the local storage policy as preliminarily adopted in step E22 for transmitting the request REQC_A. According to the “maximum” storage policy, the aggregate {Conf_Authentication} does not contain the element <MAC_AUT> and the checking is relative to the content of the aggregates {Notification} and {Authentication} that should be strictly equal to those of the aggregates {Notification} and {Authentication} respectively, preliminarily stored in the module CMP_EXP in step E22. If checking is successful, the response REPC_A is considered as valid and the method is ended. If controlling fails, the response REPC_A is ignored and the method is ended.

According to the “mean” storage policy, the controller C_EXP first controls whether the research key as contained in the response REPC_A, for example either <KI> or <KE>, corresponds to a research key preliminarily stored by the controller C_EXP in the base B_EXP. If checking is successful, the controller C_EXP checks the authentication code contained in the element <MAC_AUT> as indicated hereinbelow referring to the “minimum” storage policy. If checking fails, the response REPC_A is ignored and the method is ended.

According to the “minimum” storage policy, checking is based only on a authentication code calculation as no information element has been stored by the controller C_EXP upon generating the request REQC_A in step E22. The controller C_EXP calculates a authentication checking code on the aggregates {Notification} and {Authentication} contained in the authentication confirmation response REPC_A by using the adequate secret or private key. If the code for checking authentication is equal to the authentication code <MAC_AUT> contained in the authentication confirmation response REPC_A, then the latter is considered as valid. In the opposite case or in the absence of the authentication code <MAC_AUT>, the authentication confirmation response REPC_A is invalid and processing of step E25 is ended.

If the authentication confirmation response REPC_A is valid according to one of the three previous storage policies, the controller C_EXP controls whether the identity of the sender contained in the element <Sender> of the aggregate {Notification} is genuine relatively to the sender domain. Referring to the authentication policy as preliminarily performed upon generating the request REQC_A, if the authentication policy is “partial” or “direct”, such a checking is only relative to condition a) as set forth hereinafter, and if the local authentication policy is “total”, the checking is relative to conditions a) and b) as indicated hereinafter:
a) the element <Sender> contains an authorized identity, i.e. attributed, in the sender domain;
b) the response contained in the element <Response-Challenge> certifies that the sender terminal does indeed possess the rights necessary for claiming the authorized identity. The absence of an element <Response-Challenge> in the case of a “total” authentication policy is assimilated to a wrong element <Response-Challenge>.

Then, a communication interface of the controller C_EXP transmits an authentication response R_AUT containing a data aggregate {Rep_Authentication} typical to the sender domain towards the transport address from where the response REPC_A has been received, or alternatively towards the transport address as designated by the <Origin> domain of the aggregate {Authentication} if the latter is present.

If the identity of the sender is authenticated, the aggregate {Rep_Authentication} comprises the aggregate {Notification} such as received in the response REPC_A, an aggregate {Agreement_Sender} and optionally, an element <MAC_R_AUT>. The aggregate {Agreement_Sender} comprises an acceptation notice and information elements <KA>, <Origin> and optionally <Hour> which respectively are equivalent to the elements <KE>, <Origin> and <Hour> contained in the request REQC_A generated in step E22. The element <MAC_R_AUT> is an authentication code calculated by the controller C_EXP on the concatenation of the aggregates {Notification} and {Agreement_Sender} using for example a secret or a private key that is periodically renewed. The option for inserting the element <MAC_R_AUT> into the response R_AUT is based, similarly as for inserting the code <MAC_AUT> into the request REQC_A in step E22, on the local storage policy.

If the identity of the sender is not authenticated, the aggregate {Rep_Authentication} is comprised of the aggregate {Notification} such as received from the message REPC_A and an aggregate {Refusal_Sender} containing a refusal notice with refusal cause optionally joined to it.

During the authentication phase, the sender domain is warned about a notification request subsequently sent from the emitter domain to the recipient domain. As a consequence, the emitter domain expects from the sender domain relaying to it a notification confirmation request REQC_N received back from the notification request previously sent to the recipient domain.

The emitter domain EM thus transmits to the recipient domain DES a notification request describing the message MES that the sender wants to send to one or more recipients so that each recipient accepts or refuses the message MES, in a notification phase in steps E31 to E35 making up the step E3.

In step E31, the emitter message controller C_EM receives the authentication response R_AUT where it checks, via the key <KI> contained in the aggregate {Notification}, that it does correspond to a request previously emitted by the controller C_EM.

If the authentication response R_AUT contains a refusal notice, then the authentication of the sender terminal has failed and the notification phase is not performed, ending the method.

If the authentication response R_AUT contains an acceptation notice, then the authentication of the sender in the sender terminal has been successful and the notification phase is launched. The emitter message controller C_EM generates a notification request NOT containing the aggregates {Notification} and {Rep_Authentication}. The aggregate {Rep_Authentication} is directly extracted from the response R_AUT while the aggregate {Notification} is similar to that in the request AUT sent by the controller C_EM in step E21 and comprises, in particular, the initial key contained in the element <KI>. The aggregate {Rep_Authentication} contains in turn an aggregate {Notification} that generally comprises a reduced form of the aggregate {Notification} generated in step E21. The notification request NOT is transmitted by a communication interface of the emitter message controller C_EM to the recipient message controller C_DES or to the receiving border server SBR_DES of the recipient domain DES.

In parallel with the transmission of the notification request, information relating to the notification request are stored in the data base B_EM managed by the controller C_EM.

In step E32, the recipient message controller C_DES receives the notification request NOT and extracts therefrom the aggregates {Notification} and {Rep_Authentication}.

Optionally, the recipient message controller C_DES checks whether the transport address from where the notification request NOT has been received belongs to the addresses attributed to the emitter domain EM as a function of the address contained in the element <Emitter>.

The recipient message controller C_DES analyzes the logic address contained in the element <Sender> for determining the transport address of the border server SBR_EXP of the sender domain EXP to which the sender message controller C_EXP is coupled. Said transport address is determined by looking up preconfigured translation tables or by means of requests for resolution of domain name DNS. Optionally, the transport address is determined before processing the notification request NOT in order to save processing resources should the determination of the address fail.

The recipient message controller C_DES generates afterwards a notification confirmation aggregate {Conf_Notification} containing the aggregates {Rep_Authentication}, {Notification}, an aggregate {Notification_ACK}, and optionally an element <MAC_NOT>. The aggregates {Rep_Authentication} and {Notification} are identical to those extracted from the request NOT, and thus contain the initial key of the element <KI>. The aggregate {Notification_ACK} contains the element <Origin> and an element <KP>, and optionally the element <Hour>. The element <KP> is a token randomly generated at each notification confirmation request for uniquely identifying the notification confirmation aggregate. The element <Origin> indicates the transport address from where the notification request NOT has been received.

The element <MAC_NOT> contains an authentication code that is calculated on the aggregates {Notification} and {Notification_ACK} from a secret or private key typical to the controller C_DES. Calculating the code <MAC_NOT> and inserting the latter into the aggregate {Conf_Notification} depend on the local storage policy adopted and described in step E22.

In abbreviation, the authentication confirmation aggregate can be written:

{Conf_Notification}={Rep_Authentication}+{Notification}+{Notification_ACK}+(<MAC_NOT>),

with:

{Notification_ACK}=<KP>+(<Hour>)+(<Origin>),

and

<MAC_AUT>=MAC ({Notification}+{Notification_ACK})

where MAC is a function for calculating an authentication code using a secret or a private key, the operator ‘+’ denotes the concatenation of elements and the elements between brackets are optional.

Then the recipient message controller C_DES transmits a notification confirmation request REQC_N containing the notification confirmation aggregate {Conf_Notification}, and consequently, the initial key of the element <KI>, towards the transport address determined from the logic address contained in the element <Sender>, i.e. to the receiving border server SBR_EXP of the sender domain or to the sender message controller C_EXP.

Thus, for a “minimum” or “mean” local storage policy, processing the notification request does not impose any storage, or imposes a limited storage, respectively, of the sender message in the recipient domain able to make the recipient domain vulnerable to attacks of the service denial type.

In step E33, the sender message controller C_EXP receives the notification confirmation request REQC_N and extracts therefrom the notification confirmation aggregate {Conf_Notification} containing the aggregate {Rep_Authentication} supposed to have been generated by the sender domain, and in particular the initial key contained in the element <KI>.

In order to check whether the aggregate {Rep_Authentication} has indeed been generated by the sender domain, the sender message controller C_EXP checks the validity of the request REQC_N similarly as in step E25 and according to the local storage policy preliminarily adopted in step E22.

According to the “maximum” storage policy, the aggregate {Rep_Authentication} does not contain the element <MAC_R_AUT> and the checking is relative to the contents of the aggregates {Notification} and {Agreement_Sender} that should be strictly equal to those of the aggregates {Notification} and {Agreement_Sender}, respectively, preliminarily stored in step E25 by the module CMP_EXP.

According to the “mean” storage policy, the controller C_EXP first checks whether the research key contained in the request REQC_N, for example either <KI> or <KA>, corresponds to a research key preliminarily stored by the controller C_EXP in the base B_EXP. If the checking is successful, the controller C_EXP checks the authentication code contained in the element <MAC_R_AUT> as indicated hereinbelow referring to the “minimum” storage policy.

According to the “minimum” storage policy, checking is only based on the authentication code contained in the element <MAC_R_AUT> because no information element has been stored by the controller C_EXP upon generating the request R_AUT in step E25. The element <MAC_R_AUT> is an authentication code calculated on the content of the aggregate {Rep_Authentication} supposed to have been generated previously by the sender domain in step E25. For the request REQC_N to be valid, an authentication checking code on the content of the aggregate {Rep_Authentication} calculated by the controller C_EXP should be equal to the authentication code <MAC_R_AUT> contained in the request REQC_N. In particular, the equality of the codes <MAC_R_AUT> and of the checking is checked when the aggregate {Rep_Authentication} of the request REQC_N is identical to that generated by the controller C_EXP in step E25.

If controlling is successful, i.e. in all cases, if the initial key contained in the notification confirmation request is identical to the initial key already stored in the sender domain as a result of the authentication phase, the request REQC_N is considered as being valid and the controller C_EXP analyzes the aggregate {Rep_Authentication} for extracting therefrom the element <Origin> stored in step E25. A communication interface of the sender message controller C_EXP then transmits back the notification confirmation request REQC_N to the transport address designated by the element <Origin>, after having optionally removed the aggregate {Rep_Authentication} from the request REQC_N.

If controlling has failed, then the sender designated by the aggregate {Notification} has not been primarily authenticated by the controller C_EXP and the request REQC_N is likely to be corrupted. In such a case, the request REQC_N is not processed and the method is ended.

As soon as the request REQC_N has been transmitted back by the controller C_EXP, the latter can remove from the data base B_EXP any optional recording of the notification aggregate corresponding to the request REQC_N, the controller C_EXP no longer interfering in the following steps of the method.

Furthermore, any optional recording performed as a result of an authentication phase during steps E22 or E25 can be removed after a predetermined period of time so as not to submit the controller C_EXP to possible attacks of the service denial type.

In step E34, the emitter message controller C_EM receives the notification confirmation request REQC_N and extracts therefrom the notification confirmation aggregate {Conf_Notification}, in particular, the aggregate {Notification} it contains. The controller C_EM checks whether the received aggregate {Notification} in the request REQC_N does correspond to a notification request preliminarily generated by the emitter domain, for example checking that the key <KI> extracted from the aggregate {Notification} correspond to a key already stored in the data base B_EM.

If the received aggregate {Notification} is identical to a notification already stored in the data base B_EM, a communication interface of the emitter message controller C_EM transmits a notification confirmation response REPC_N containing the notification confirmation aggregate {Conf_Notification} such as extracted from the request REQC_N, after having removed the aggregate {Response_Authentication} if appropriate, towards the transport address to which the notification request NOT has been sent, i.e. towards the controller C_DES.

In contrast, if the received aggregate {Notification} is not identical to any notification already stored in the data base B_EM of the controller C_EM, the request REQC_N is not processed and the method is ended.

Furthermore, if after a predetermined period of time following step E31, no notification confirmation request REQC_N has been received by the controller C_EM responsive to a previous notification request NOT transmitted by the controller C_EM, the emitter domain reinitiates a notification phase by again transmitting a notification request to the controller C_DES, considering that the previous notification phase has failed.

In step E35, the recipient message controller C_DES receives the notification confirmation response REPC_N and extracts therefrom the notification confirmation aggregate {Conf_Notification}.

Optionally, the controller C_DES controls the time validity of the response, on the basis of the element <Hour>. The same element <Hour> can be used by the controller C_DES for finding the secret or private key that it had used for calculating the notification code <MAC_NOT> in the notification confirmation request REQC_N. Such a checking is only useful if the controller C_DES uses periodically renewed secret or private keys.

Then the controller C_DES checks the validity of the response REPC_N similarly as in step E25 or E33 and according to the local storage policy preliminarily adopted in step E32 as a function of the elements {Notification}, {Notification_ACK} and the element <MAC_NOT> if applicable.

If controlling is successful, then the notification confirmation response REPC_N is considered as being valid. In the opposite case, the notification confirmation response REPC_N is invalid and the following steps are not executed by the recipient domain controller C_DES, ending the method.

If the notification confirmation response REPC_N is valid, the controller C_DES looks up lists of sender addresses in the data base B_DES, including the white list LBDD of addresses authorized within the recipient domain, the white list LBSD of addresses authorized within a sub-domain of the recipient domain and the white list LBU of addresses authorized by a particular user. The controller C_DES can further look up the black lists of forbidden addresses LNDD, LNSD and LNU. Looking up the lists in the data base B_DES indicates to the controller C_DES if the sender address is authorized, for at least one recipient, so as to acknowledge the message MES from such an address.

From the list of recipients {<Recipient>} extracted from the aggregate {Notification}, the controller C_DES then generates a refusal list LR, a definitive agreement list LAD and a provisional agreement list LAP as a function of the lists looked up.

The refusal list LR includes identifiers of the recipients for which receiving the message MES is refused, either because such recipients do not exist in the recipient domain, or because the sender address occurs at least in one of the lists LNDD, LNSD or in one of the lists LNU relating to such recipients.

The definitive agreement list LAD includes the identifiers of the recipients for which receiving the message MES is definitely granted. The condition for a recipient to be added to this list is that the sender address does not occur in any of the lists LNDD or LNSD or in the list LNU relating to this recipient, and, that conversely the sender address occurs in the lists LBDD or LBSD or in the list LBU relating to this recipient.

The provisional agreement list LAP includes the identifiers of the recipients for which receiving the message MES has been provisionally granted, i.e. neither refused nor accepted a priori, as opposed to the recipients having been identified respectively in the lists LR and LAD.

Finally, the cardinal number of the list {<Recipient>} is equal to the sum of the cardinal numbers of the lists LR, LAD and LAP among which at least one of these three is not empty.

In an embodiment, the controller C_DES generates the list LR, respectively LAD, without making use of the lists LNDD or LNSD or LNU, respectively LBDD or LBSD or LBU, for example gathering explicit refusals, respectively agreements, of the recipients identified in the notification. In all cases, the list LAP contains the identifiers of the recipients not included both in the list LR and in the list LAD.

If at least one of the lists LAP or LAD is not empty, the controller C_DES stores the notification aggregate {Notification} such as extracted from the response REPC_N and optionally the associated generated lists LR, LAP, LAD. The controller C_DES afterwards produces a notification response R_NOT containing the notification aggregate {Notification} such as extracted from the response REPC_N and reduced to its most compact possible form, and the generated lists LR, LAD and LAP. The notification response R_NOT is transmitted to the transport address from where the response REPC_N comes or alternately to the transport address designated by the element <Origin> of the aggregate {Notification_ACK}, i.e. the address from where the notification request NOT has been received.

If the definitive agreement list LAD is not valid and includes at least one recipient identifier, i.e. if at least a recipient has already provided its agreement for receiving the message MES explicitly or implicitly by means of a list LBDD, LBSD or LBU, the notification response R_NOT further contains a definitive key KD.

In step E4, the emitter message controller C_EM receives the notification response R_NOT and extracts therefrom the lists LR, LAD and LAP. The controller C_EM presents the lists LR, LAD and LAP to the sender message MES who is thus informed about the recipients who have refused the notification request, those who have accepted it and those for whom an explicit agreement request is necessary.

If the definitive agreement list LAD is not empty, the controller C_EM extracts from the notification response R_NOT the corresponding definitive key KD and produces an authenticated message MA containing the initial message MES received in step E1 and the definitive key KD. The authenticated message MA is transmitted towards the same transport address as the one from where the response R_NOT has been received from, or alternatively towards the address to which the notification request NOT or the notification confirmation response REPC_N has been transmitted.

In step E5, the recipient message controller C_DES receives the authenticated message MA containing the message MES and the definitive key KD and checks the validity of the latter with respect to a notification preliminarily recorded in step E35.

If the definitive key KD is valid, the recipient message controller C_DES recovers the corresponding notification aggregate {Notification}, such as stored by the controller C_DES in step E35. Furthermore, the controller C_DES can also control the message integrity of the received message MES by means of the message signature provided by the element <Signature> if the latter is present in the same notification aggregate.

Then the controller C_DES transmits the message MES to the recipients whose identifiers are included in the definitive agreement list LAD, such as stored by the controller C_DES in step E35 before the transmission of the notification response R_NOT, so as to prevent any malicious emitter from modifying the list of recipients between the transmission of the notification request NOT and the transmission of the authenticated message MA. The controller C_DES transmits the message MES to the recipient terminals TD or to the addresses of the recipients.

If the definitive key KD is not valid, the message MES is not transmitted to the recipients, the message having been optionally impaired by a malicious third party, and the method is ended.

Returning to step E35, if the provisional agreement list LAP includes at least the identifier of a recipient, the recipient should give an explicit agreement or refusal for receiving the message MES described in the notification request NOT.

To this end, the recipient message controller C_DES presents to the recipient terminal information coming from the aggregate {Notification} relating to the sender of the message MES, such as the address or the identifier of the sender, in step E6. Then, upon the request from the recipient message controller C_DES, the recipient explicitly provides the controller C_DES with his agreement or his refusal for receiving the message MES. The controller C_DES then updates the content of the list LAD or LR as a function of the explicit agreement or the refusal provided by the recipient.

Furthermore, the controller C_DES can also update the black list LNU and the white list LBU relating to the recipient. Advantageously, the controller C_DES can regularly look up the black and white lists of each recipient so as to update the white lists LBDD and LBSD and the blacks lists LNDD and LNSD relating to the recipient domain.

When all the agreements and/or refusals have been recovered by the controller C_DES for all the recipients contained in the list LAP, the latter generates a second notification response R_NOT2 containing the updated lists LR and LAD and transmits it to the controller C_EM so that the latter indicates to the sender the complementary recipients having accepted and/or refused the message MES.

Then in step E7, the recipient message controller C_DES transmits the message MES to the recipient terminals TD or to the recipient addresses that explicitly gave their agreement.

If the provisional agreement list LAP generated by the controller C_DES in step E35 is empty, steps E6 and E7 are not executed.

In an embodiment, as providing the agreement or the refusal for receiving the message MES by each recipient of the list LAP can be delayed for example by the absence of at least one recipient, step E6 can be executed a number of times, according to the number of recipients linked to the list LAP. In such a case, step E7 is repeated several times so that the controller C_DES transmits the message MES only to the terminals of recipients TE who have explicitly given their agreement, even if other recipients have not yet given their agreement.

In an embodiment, the controller C_DES transmits the second notification response R_NOT2 containing the updated lists LR and LAD to the controller C_EM after having transmitted the message MES to the terminals TD of the recipients who have explicitly given their agreement.

In another embodiment, if the provisional agreement list LAP generated in step E35 includes at least one identifier of a recipient and if the definitive agreement list LAD is empty, the notification response R_NOT transmitted in step E35 does not contain any definitive key KD. In such a case, steps E4 and E5, during which the authenticated message MA containing the message MES and the definitive key KD is transmitted from the emitter message controller C_EM successively to the recipient message controller C_DES, then to the recipients, are performed after step E6. During step E6, the controller C_DES transmits the second notification response R_NOT2 containing the updated lists LR and LAD and a definitive key KD to the controller C_EM, i.e. after at least one recipient have provided his explicit agreement for receiving the message MES. Consequently, the emitter domain transmits the authenticated message MA to the recipient domain after having received the second notification response R_NOT2 containing the updated definitive agreement list including at least one identifier of a recipient.

In another embodiment, the identity of the sender is managed by the emitter domain EM and the sender domain EXP and emitter domain EM are merged between them. In such a case, step E2 relating to the authentication phase only comprises step E23, during which the sender terminal TE replies to the challenge optionally transmitted by the emitter message controller C_EM so that the latter authenticates the sender of the message MES. Furthermore, steps E32 and E33 only form one single step during which the recipient message controller C_DES transmits the notification confirmation request REQC_N directly towards the emitter message controller C_EM and no longer towards the sender domain.

In another embodiment, the emitter message controller C_EM is included in the sender terminal and does not execute any of the steps of the method according to the invention automatically. In each step during which the controller C_EM interferes, the latter indicates to the sender via the sender terminal TE the instructions to be followed for executing the step. For example, the instructions are displayed on a screen of the sender terminal and the sender manually takes part in creating the requests and responses relating to the authentication and notification phases.

The invention as herein described relates to a method and two entities respectively included in an emitter domain and a sender domain for controlling a message to be transmitted by a sender terminal connected to the emitter domain towards a recipient domain via a telecommunications network, the sender being administratively or contractually linked to the sender domain. According to an implementation, the steps in the method of the invention are determined by instructions of computer programs incorporated respectively into the entities of the invention. The programs include program instructions which, when said programs are executed respectively in said entities, whose operation is then controlled by executing the programs, perform the steps in the method of the invention.

Consequently the invention also applies to a computer program, including computer programs stored on or in a storage medium readable by a computer and any data processing device, adapted to implement the invention. This program may be written in any programming language and take the form of source code, object code, or intermediate code between source code and object code, e.g. in a partially compiled form, or any other form suitable for implementing the method of the invention.

The storage medium may be any entity or device capable of storing the program. For example, the medium may comprise storage means on which the computer program of the invention is stored, such as a ROM, for example a CD-ROM or a microelectronic circuit ROM, or USB key, or magnetic storage means, for example a diskette (floppy disk) or hard disk.

Furthermore, the storage medium may be a transmissible medium such as an electrical or optical signal, which may be routed via an electrical or optical cable, by radio or by other means. The programs of the invention may in particular be downloaded over an internet type network.

Alternatively, the storage medium may be an integrated circuit into which the program is incorporated, the circuit being adapted to execute the method of the invention or to be used in the execution of the method of the invention.

1. A method of controlling a message to be transmitted by a sender terminal connected to an emitter domain, to a recipient domain, the sender being linked to a sender domain, said method comprising the following steps, as a result of authenticating said sender of said message by said sender domain:
transmitting sender domain data from said sender domain to said emitter domain and a notification request including said sender domain data from said emitter domain to the recipient domain,
in response to said notification request, transmitting a notification confirmation request including said sender domain data from said recipient domain to said sender domain,
if the sender domain data included in the notification confirmation request are identical to the sender domain data transmitted from said sender domain as a result of the authentication of said sender, transmitting said notification confirmation request from said sender domain to said emitter domain, and
in response to said notification confirmation request, transmitting a notification confirmation response from said emitter domain to said recipient domain.

2. A method as claimed in claim 1, wherein after receiving the notification confirmation response, said recipient domain generates a refusal list, a definitive agreement list and a provisional agreement list including identifiers of recipients for which a reception of said message is respectively refused, definitively agreed and provisionally agreed, and transmits a first notification response including the lists to said emitter domain.

3. A method as claimed in claim 2, wherein, if said definitive agreement list includes at least a recipient identifier, said first notification response includes a definitive key, and after receiving said notification response, said emitter domain transmits an authenticated message including said message and said definitive key to said recipient domain so that said recipient domain transmits said message to at least one terminal of a recipient, the identifier of which is included into said definitive agreement list, after validating said definitive key included in said authenticated message.

4. A method as claimed in claim 2, wherein if said provisional agreement list includes at least the identifier of a recipient, upon request from said recipient domain, said recipient gives one of an agreement and a refusal for receiving said message to the recipient domain, so that said recipient domain transmits said message to said recipient terminal.

5. A method as claimed in claim 4, including in said recipient domain updating said refusal list and said definitive agreement list as a function of one of an agreement or a refusal provided by said recipient and transmitting a second notification response including the updated refusal list and definitive agreement list to said emitter domain.

6. A method as claimed in claim 5, wherein if in said first notification response said provisional agreement list includes at least one identifier of a recipient and if said definitive agreement list is empty, said emitter domain transmits said message to said recipient domain after having received said second notification response including the updated definitive agreement list including at least one recipient identifier.

7. A method as claimed in claim 1, wherein authenticating said sender of said message further comprises authenticating an identity of said sender and validating rights needed for claiming said identity by said sender domain, as a result of an exchange of data between said sender domain and said sender terminal.

8. A system of for controlling a message to be transmitted by a sender terminal connected to an emitter domain, to a recipient domain, the sender being linked to a sender, said system comprising:
a transmitter arrangement in said sender domain for transmitting sender domain data to said emitter domain, as a result of an authentication of the message sender by said sender domain,
a transmitter arrangement in said emitter domain for transmitting a notification request including said sender domain data to said recipient domain,
a transmitter arrangement in said recipient domain for transmitting a notification confirmation request including said sender domain data to said sender domain in response to said notification request,
a transmitter arrangement in said sender domain for transmitting said notification confirmation request to said emitter domain, if the sender domain data included in said notification confirmation request are identical to the sender domain data transmitted from said sender domain as a result of said authentication of said sender, and
a transmitter arrangement in said emitter domain for transmitting a notification confirmation response to the recipient domain in response to said notification confirmation request.

9. A system as claimed in claim 8, wherein said emitter domain and said sender domain are merged between them.

10. An entity in an emitter domain for controlling a message to be transmitted by a sender terminal connected to said emitter domain, to a recipient domain, the sender being linked to a sender domain, said entity being adapted for:
transmitting a notification request including data from said sender domain to said recipient domain, after receiving said data transmitted by said sender domain as a result of an authentication of said sender of said message by said sender domain, so that in response to receiving said notification request, said recipient domain is adapted to transmit a notification confirmation request including said data to said sender domain, and
transmitting a notification confirmation response to said recipient domain in response to said notification confirmation request transmitted from said sender domain to said emitter domain, if the data included in said notification confirmation request are identical to the data contained in said notification request and transmitted from said sender domain as a result of said authentication of said sender.

11. An entity in a sender domain for controlling a message to be transmitted by a sender terminal connected to an emitter domain, to a recipient domain, the sender being linked to the sender domain, said entity being adapted for:
transmitting data from said sender domain to said emitter domain, as a result of an authentication of said sender of said message by said sender domain, and
transmitting back a notification confirmation request including said data to said emitter domain, if the data included in said notification confirmation request are identical to the data transmitted from said sender domain as a result of said authentication of said sender, said notification confirmation request having been transmitted from said recipient domain to said sender domain in response to a notification request including the data transmitted from said emitter domain to said recipient domain as a result of said authentication of the sender, so that said emitter domain is adapted to transmit a notification confirmation response to said recipient domain.

12. A computer readable medium or storage device storing a computer program for causing a data processor arrangement in an emitter domain to control a message to be transmitted by a sender terminal connected to said emitter domain, to a recipient domain, the sender being linked to a sender domain, said computer program, when executed in said data processor arrangement, causes the processor arrangement to perform the following steps:
transmitting a notification request including data from said sender domain to said recipient domain, after receiving said data transmitted by said sender domain as a result of an authentication of said message of said sender by said sender domain, so that in response to receiving said notification request, said recipient domain is adapted to transmit a notification confirmation request including said data to said sender domain, and
transmitting a notification confirmation response to said recipient domain in response to said notification confirmation request transmitted from said sender domain to said emitter domain if the data included in said notification confirmation request are identical to said data transmitted by said sender domain as a result of said authentication of said sender.

13. A computer readable medium or storage device storing a computer program for causing a data processor arrangement in a sender domain to control a message to be transmitted by a sender terminal connected to an emitter domain, to a recipient domain, the sender being linked to said sender domain, said computer program, when executed in said data processor arrangement, causes the processor arrangement to perform the following steps:
transmitting data from said sender domain to said emitter domain, as a result of an authentication of said sender of said message by said sender domain, and
transmitting back a notification confirmation request including said data to said emitter domain, if the data included in said notification confirmation request are identical to the data transmitted from said sender domain as a result of said authentication of said sender, said notification confirmation request having been transmitted from said recipient domain to said sender domain in response to receiving a notification request including the data transmitted from said emitter domain to said recipient domain as a result of said authentication of said sender, so that said emitter domain is adapted to transmit a notification confirmation response to said recipient domain.
